(19) United States
(12) Patent Application Publication
(10) Pub. No.: US 2018/0181694 A1
(43) Pub. Date: Jun. 28, 2018

(54) METHOD FOR OPTIMIZING A PROCESS OPTIMIZATION SYSTEM AND METHOD FOR SIMULATING A MOLDING PROCESS

(71) Applicant: ENGEL AUSTRIA GmbH, Schwertberg (AT)

(72) Inventors: Klemens SPRINGER, Leonding (AT); Anton Frederik STOEHR, St. Valentin (AT); Georg PILLWEIN, Linz (AT); Friedrich Johann KILIAN, Neuhofen / Krems (AT)

(21) Appl. No.: 15/845,159

(22) Filed: Dec. 18, 2017

(30) Foreign Application Priority Data
Dec. 23, 2016 (AT) A 51185/2016

(51) Int. Cl. G06F 17/50; B29C 45/76

(52) U.S. Cl. CPC G06F 17/5009; B29C 45/766; G06F 2217/41; B29C 2945/76946; B29C 2945/76993; B29C 2945/76949; B29C 2945/76434

(57) ABSTRACT

A method of optimizing a process optimization system for a moulding machine includes setting a setting data by a user on the actual moulding machine, obtaining first values for at least one descriptive variable of the moulding process based on the setting data set and/or on the basis of the cyclically carried out moulding process, and obtaining second values for the at least one descriptive variable based on data from the process optimization system. According to a predetermined differentiating criterion, it is checked whether the first values and the second values differ from each other. If the checking shows that the first values and the second values differ from each other, the process optimization system is modified such that, when applied to the moulding machine and/or the moulding process, the first values for the descriptive variable substantially result instead of the second values for the descriptive variable.

The present invention relates to a method for optimizing a process optimization system for a moulding machine, by means of which a cyclic moulding process is carried out for the production of a moulded part. The present invention also relates to a method for simulating a moulding process according to the features of the preamble of claim 14.

Moulding machines can be, for example, injection-moulding machines, transfer-moulding presses, compression-moulding presses and the like. Moulding processes use this terminology analogously.

State of the art are firstly machine learning on the basis of neural networks (see for example EP 0 901 053 or DE 44 16 317), fuzzy systems or combinations of these (see for example DE 10 2004 026 641 or DE 42 09 746) for optimal process parameter determination using metrological equipment on the injection-moulding machine. Secondly, central control and regulation of an injection-moulding system using this optimal process parameter setting is known.

Included therein is, depending on availability, access to process settings for already computed moulded parts as well as the transmission of the optimal process settings from a central memory.

These methods are limited to the extent that only moulding processes for the production of moulded parts that are used for the training as well as ones similar to these can be optimally set. As a rule, moulded parts that differ to a greater extent therefrom cannot be optimally set, as the methods train the process setting directly, but not the setting procedure itself.

In a first variant of the invention, the object can be regarded as seeking to broaden the applicability of the process optimization systems.

This object is achieved by the features of claim 1.

This occurs in that
(a) a setting data set is set by a user on the actual moulding machine,
(b) first values for at least one descriptive variable of the moulding process are obtained on the basis of the setting data set and/or on the basis of the cyclically carried out moulding process,
(c) second values for the at least one descriptive variable are obtained on the basis of data from the process optimization system,
(d) according to a predetermined differentiating criterion, it is checked whether the first values and the second values differ from each other and,
(e) if method step (d) shows that the first values and the second values differ from each other, the process optimization system is modified such that, when applied to the moulding machine and/or the moulding process, the first values for the at least one descriptive variable substantially result instead of the second values for the at least one descriptive variable.

The process optimization system is abbreviated to POS. In the following description, reference is also made to system parameters of the POS. These define a given POS in the sense that changes to the system parameters in the case of an unchanging “architecture” of the POS bring about a changed behaviour of the POS.

Core aspects of the invention are the identification of differences between descriptive variables of actual and simulated injection-moulding machines and the subsequent optimization of the process optimization system. Descriptive variables describe a wide variety of aspects of the moulding process. Examples are indicated below.

Within the framework of the invention, mould data, machine data, material data, process data, measured data, user data and quality data can be transmitted from decentralized injection-moulding machines to a central data memory via remote data transmission connection. The identification and evaluation of the quality parameters as well as their effect on process setting parameters can be learned on the basis of quality parameters determined by means of simulation and/or transmitted descriptive variables. The POS trained using actual data or the system parameters of the modified POS necessary for this can be transmitted to decentralized injection-moulding machines via remote data transmission connection. The modification of the system parameters of the process optimization system can thus also be regarded as a modification of the process optimization system within the meaning of method step (e). The system parameters can include the second values of the at least one descriptive variable.

The modified process optimization system need not be applied to a moulding machine or a moulding process directly after the method according to the invention has been carried out. Instead the process optimization system, e.g. in the form of the modified system parameters of the process optimization system, can be transmitted prior to this.

The predetermined differentiating criterion can be implemented, for example, via predefined bounds for the difference between different parameters of the setting data sets.

The setting of the setting data set by a user on the actual moulding machine can in particular also be effected supported by the process optimization system.

Method step (c) can be carried out before, after or between method steps (a) and (b).

A second variant of the invention relates to a method for simulating a moulding process, wherein
configuration data which relate to the moulding process to be simulated are provided on a user's computer,
the configuration data are transmitted by means of a remote data transmission connection to a memory which is separate from the moulding machine and stored therein,
a simulation program stored in the memory is executed, using the configuration data, on a computer which is connected to the memory and is separate from the moulding machine and
results generated by means of the simulation program are output.

EP2679376 discloses a specific method for all-electric injection-moulding machines, wherein simulations of injection-moulding processes are carried out in a cloud server and are stored in cloud storage.

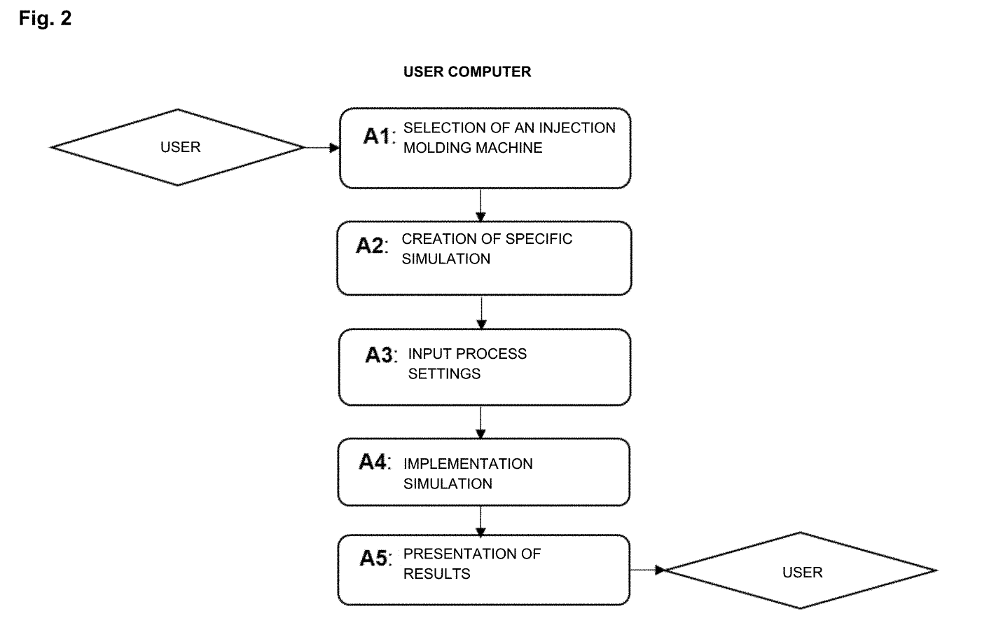

In moulding machine construction, it is unproductive to be limited in the case of simulations to electrical machines and/or, also, to disregard the machine dynamics in order to derive assertions or correlations. When considering the machine in detail, the possible variability of the physical setup is already considerable. This has the result that at the current time simulations have been developed only for selected machines, usually also due to the considerable complexity of the correlations, see FIG. 2 (A1)-(A2). As a consequence of the variance and owing to this conventional approach, there is virtually no possibility of continuously creating digital reproductions of moulding machines.

Furthermore, if the overall configuration of a moulding process simulation is considered, mould data and material data of the plastic to be injected are also required in addition to machine setup (e.g. of the hydraulic or electric drive system) and machine data, such as masses, lengths, inertias, etc. At the time a simulation is created, usually during the production of the actual moulding machine, required data sets such as material or mould data on a local user's computer are unknown or are variable. This also has the consequence that, with current approaches, a simulation that is designed for the specific application case with a specific mould and specific material parameters is created at the time the moulding machine is used (A2).

The material parameters required for the configuration of the simulation are collected on a local user's computer and made available for the creation of the simulation. If the same materials are used again on a further local user's computer, the material data have to be collected again and made available to the simulation.

The performance of a moulding process simulation (A4) (above all in the case of performance of CFD simulations) results in the need for a high-performance hardware installation. If a simulation is carried out by different users, or from different geographical locations, a considerable soft- and hardware installation outlay is necessary.

Additionally, in the case of local performance of simulations, the distribution and further use of simulation results (A5) has proved to be laborious, as the evaluation of the results has to be carried out redundantly.

In summary, local simulation, parameterized for a specific machine application, has clear disadvantages with respect to soft- and hardware outlay, evaluation possibilities, parameterization of the simulation (which has to be carried out from the beginning again and again). In addition, there is virtually no possibility of setting up a modular simulation in order to test different application cases easily. Furthermore, known central simulations (cloud servers) also have clear disadvantages when carried out disregarding physical effects or further limitations (electrical machine configuration), because they are too imprecise with respect to controller dynamics, machine dynamics and delay times. In the second variant of the invention, the object is therefore to provide a simplified method for simulating a moulding process which allows in particular a simpler optimization of a moulding process.

This object is achieved by the features of claim 14. This occurs in that simulation parameters are automatically provided on the basis of the configuration data.

The configuration data merely contain a reduced quantity of abstract, descriptive variables such as e.g. the material name or size and type of the injection unit. Process- and simulation-relevant physical variables (the simulation parameters), such as for example viscosity, inertia, friction and the like, are obtained from a central database, for example, by a simulation creation program on the basis of the abstract variable.

The invention according to the second variant ultimately allows a “web-based” simulation of the moulding process. The invention in its second variant is applicable in the same situations as in its first variant.

The present invention therefore provides the possibility of configuring and simulating a moulding process, wherein the simulation is carried out on a central computer connected via remote data transmission connection.

In other words, by means of access via remote data transmission connection to a central computer a simulation for computing a moulding process can be configured, parameterized and carried out. The results can then be transmitted by means of remote data transmission connection to a local user's computer and used further.

In addition to the actual moulding process, the simulation can include the charging, closing and demoulding operations.

The computer which is separate from the moulding machine and the user's computer is also known as the “central computer”. This applies analogously to the memory which is separate from the moulding machine and the user's computer. The central computer and the central memory can be realized in one physical unit. However, this is not absolutely necessary for the invention. In particular, the central computer and the central memory can be realized as a cloud computer or cloud storage.

Further advantageous embodiments are defined in the dependent claims.

In a first variant of the invention, it can be provided that the setting data set contains process setting parameters relating to at least one of the following: clamping force, shot volume, injection speed, switchover point, injection cylinder temperature, mould temperature, control and/or regulating parameters, holding pressure profile, holding pressure time, screw rotation speed, back pressure profile, cooling time, injection pressure limit, decompression stroke, tempering medium flow rate.

It can be provided that, within the framework of carrying out method step (c) in a simulation of the moulding machine and/or of the moulding process, the process optimization system is applied and the second values are at least partially obtained from results of the simulation.

In an embodiment preferred in this regard, the return of measured data, machine data, material data, mould data, process data, user data and quality data from decentralized injection-moulding machines to a central data memory via remote data transmission connection can be provided in order to train a process optimization system (POS) (e.g. on the basis of fuzzy logic, neural networks, expert systems, or the like) for the optimal setting of a moulding machine in a possibly central processing unit by means of e.g. machine learning. In an embodiment example in which the modified process optimization system is actually applied to an actual moulding machine, by an optimal setting is meant a setting data set which, when used on a moulding machine, minimizes/maximizes at least one of the following quality criteria of a moulding process: reduced waste, reduced cycle time, improved moulding quality.

In one embodiment example, the method according to the invention makes it possible to train a process optimization system in such a way that a moulding process or an injection-moulding simulation aligned with measured data is optimally set (thus the process parameters are optimally set).

In the simulation, quality parameters (not necessarily measurable in the actual process) can be evaluated and dependencies learned, with the result that ultimately the process optimization system would decide similarly to or more optimally than the users used for the training.

For example, general correlations between these quality parameters and process setting parameters can be determined from quality parameters calculated by means of simulation. For this, the actual moulding process can be ideally reproduced in the simulation by means of transmitted descriptive variables and quality parameters can be determined therefrom. These quality parameters include among others flow front velocity, degree of filling, warpage, sink marks, weight, etc.

Thus, in contrast to the state of the art, with a method according to the invention not only can a particular moulding machine be controlled or regulated, but a preferably centrally available process optimization system (POS) can be trained.

By an expert system in the sense understood here can be meant an intelligent database integrated in a computer system (see e.g. Krishnamoorthy, C. S. and S. Rajeev (1996): Artificial Intelligence and Expert Systems for Engineers, Boca Raton: CRC Press, pages 29-88). It contains systematized and programmed-in basic knowledge about the rules of the moulding process, as can be found e.g. in the relevant literature (cf. SchOtz 2016—Abmusterung von Spritzgießwerkzeugen. Chapters 4-8; Jaroschek 2013—Spritzgießen für Praktiker. Chapters 3-4; Fein 2013—Optimierung von Kunststoff-Spritzgießprozessen. Chapters 4-6, Lüdenscheid Plastics Institute—Störungsratgeber). In addition, in an expert system rules can be programmed in, which represent generalizations of procedures for machine setting, defect detection or defect prevention by experienced process technicians and specialists for setting moulding machines. Such a system of rules or basic knowledge can exist e.g. in the form of truth functions or lookup tables. In the case of known moulded part geometries, materials, machines and quality requirements, on the basis of the programmed-in knowledge and the rules an expert system can make rough estimates of ranges of process parameters, which result in effective machine settings. On the basis of programmed-in correlations between process conditions, machine settings, component qualities, and materials, it can carry out necessary modifications of the process parameters following an identification of quality criteria which were not met with process parameters previously used.

It can be provided that the modified process optimization system is used in the case of the moulding machine and/or in the case of further moulding machines.

It can be provided that the modification of the process optimization system occurs by machine learning and/or numerical optimization methods and/or adaptation of an expert system.

It can in particular be provided that, during the modification of the process optimization system, an error function between the first values and the second values is minimized for the at least one descriptive variable.

During the modification of the POS, the system parameters of the fuzzy logic systems, neural networks, mathematical models, expert systems and the like of the POS can in particular be learned by e.g. machine learning/numerical optimization methods/adaptation of an expert system or other suitable methods using the actual and simulated process settings, measured and simulation data as well as descriptive variables. The simulation of the injection-moulding process can be assumed to be very realistic—to the point of being practically identical—by the minimization of error functions of measured and model variables for model alignment.

It can in particular be provided that the adaptation of an expert system is carried out by modification of lookup tables.

It can be provided that at least one of method steps (c), (d) and (e) is carried out on a computer which is separate from the moulding machine, wherein the first values for the at least one descriptive variable are transmitted to the computer, preferably via a remote data transmission connection.

It can be provided that at least one of the following is stored in a memory which is separate from the moulding machine—preferably after transmission by means of a remote data transmission connection: the first values of the at least one descriptive variable, the second values of the at least one descriptive variable, the modified process optimization system.

It can be provided that the at least one descriptive variable includes parameters of the setting data set which were set by users.

It can be provided that the at least one descriptive variable includes one or more of the following:
machine data which relate to a moulding machine used in the moulding process,
mould data which relate to a mould used in the moulding process,
material data which relate to a material used in the moulding process,
process settings and measured data which relate to the moulding process itself,
user-related data (such as for example user role, user level)
quality parameters which describe the moulded part (such as for example dimensions, mass, degree of filling, warpage, sink marks, flow front velocity).

As mentioned, quality parameters can, however, be used not only for evaluating the quality of the moulding process, but also for identifying which of these parameters have to be evaluated and the way in which they have to be evaluated. Quality parameters can thus also be advantageous for discovering correlations between particular setting data sets (and individual parameters therefrom) and the quality parameters (“pattern recognition”). During the corresponding modification of the POS, it can then be assumed that the modified POS (according to (e)) suggests process settings which produce moulded parts with improved or optimized quality parameters. Some quality parameters can also be determined on the actual moulded part.

It can be provided that the process optimization system makes use of at least one of the following: neural network, mathematical model, expert system, fuzzy logic.

When a mathematical model is used for the simulation, it can be provided that parameters of the mathematical model describing the simulation (model parameters) are determined by minimizing error functions of measured and model variables.

The calculated parameters can be stored in separate memories, already mentioned.

It can be provided that the process optimization system is used to improve setting data sets for moulding machines, wherein at least one of the following quality criteria is preferably used as criterion for an improvement: reduced waste, reduced cycle time, improved moulding quality.

In addition to the setting data set which is usually input on the moulding machine by the user, further user inputs can be made, which are, for example, at least one of the following variables describing the process:

1. mould data (weight, geometry of the cavity, etc.)
2. machine data (machine configuration=>masses, lengths, limits, etc.)
3. material data (viscosity, density, etc.)
4. measured data (injection pressure measurement, etc.)
5. user-related data (user role, user level, etc.)
6. quality data (moulded part dimensions, moulded part weight, etc.)

The simulation of the moulding process can take into account for example a screw that is axially movable in a cylinder, a runner and/or cavity system.

A moulding method to be simulated in this way can proceed as follows: the screw is moved axially either by means of a ball screw or hydraulic cylinder.

This movement is implemented through rotation of the ball screw by electric motor or through pressure build-up in the hydraulic cylinder by hydraulic pump. The plastic material located in the cylinder space in front of the screw is injected by the forwards motion via a nozzle into the runner system and subsequently into the cavities. The material is compressed and pressure is built up. When a position-, time- or pressure-dependent switchover point is reached, a predetermined course of the specific injection pressure is regulated. The flow of the material into the cavities is determined by means of fluid-dynamic calculation. A device for shooting pot methods can be attached to the nozzle.

The simulation of the charging can include the rotational motion of the screw taking into account the plasticizing process of the material to be injected. Starting at an inlet (material cylinder), plastic is moved forwards through the screw channels by means of rotational motion and melted. The movement can be implemented through rotation by electric or hydraulic motor.

The simulation of the closing of the mould can take into account the mechanism of the clamping unit used, the mould used as well as an electric/hydraulic drive system. The mechanism can be represented by five-point toggle kinematics, three-point toggle kinematics and a hydraulic cylinder. In the last two systems, due to a tie-bar-less design of the clamping unit, a link for retaining the platen parallelism can be taken into account in terms of structural mechanics.

The simulation of the demoulding can take into account an axial forwards motion of an ejector plate and the ejection of the moulded part from the mould.

The simulation can be configurable to a great extent. During the creation of the simulation, this means that the following are made possible:
configurability of the topology of a hydraulic network (drive system)
selection of subcomponents such as motors, pumps, mechanisms
variability of machine parameters (lengths, masses, inertias, motor constants, efficiencies, etc.)
variability of software-based control systems (trajectory generator, regulating system, etc.)
configurability of process settings (clamping force, shot volume, etc.)
configurability of the mould used (geometry, runner position, cooling channels)
variability of material parameters of the plastic to be injected, such as viscosity, compressibility, specific volume, temperature constant, etc.
configurability of environmental influences such as temperature, pressure and disturbances

The configuration of the simulation which is necessary for this is carried out using a user's computer and/or on the basis of the transmitted descriptive variables of the moulding process and transmitted to a central computer.

Furthermore, the associated control systems can be derived.

The central database can also be enlarged and improved by identifying physical variables during actual moulding processes on the machine. Parameter variations and new materials can thereby be recorded.

By means of the transmitted configuration data, the simulation is created with automatic provision of the simulation parameters on the central computer. A digital reproduction of the machine is therefore available.

Users can configure process settings in order to be able to run through a complete moulding cycle. These process settings can relate among others to the opening stroke, clamping force, shot volume, injection speed, switchover point and holding pressure settings. Settings or specifications on the moulding machine in this regard can then be transmitted to the central computer.

The simulation is carried out on the central computer and the results are stored in the memory connected to the central computer.

After the simulation has been carried out, the results can be transmitted to any desired local users' computers and displayed. This action can take place in parallel. The computing power for computing the simulation is only needed on the central computer.

The interpretation and the subsequently appropriate display of the interpreted data can take place on the central computer or also, after the remote data transmission, on the local user's computer. Different algorithms, adapted for the simulation carried out, can be used for the interpretation of these data.

Further advantages and details of the invention are to be found in the figures and the embodiment examples described below. There are shown in:

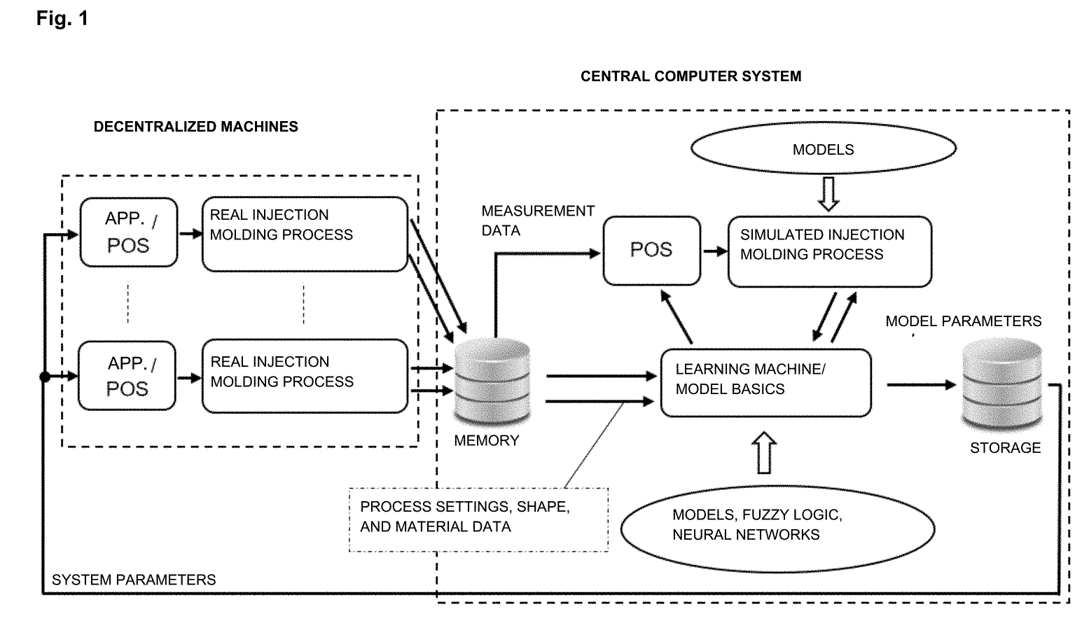

FIG. 1 a schematic drawing to illustrate the structure of the objects involved in the first embodiment example (according to the first variant of the invention),

FIG. 2 a flow diagram of a simulation method according to the state of the art,

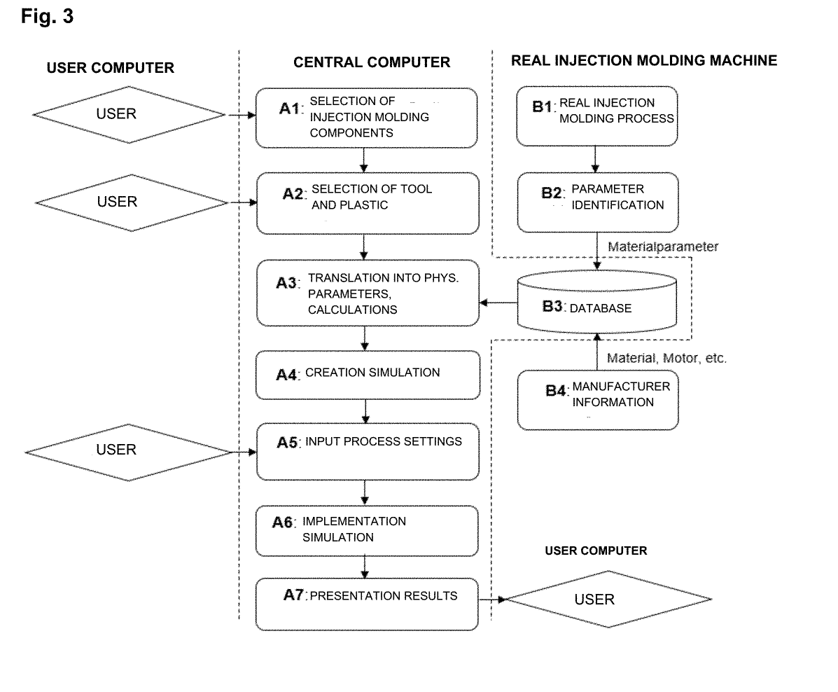

FIG. 3 a flow diagram of an embodiment example (according to the second variant of the invention) and

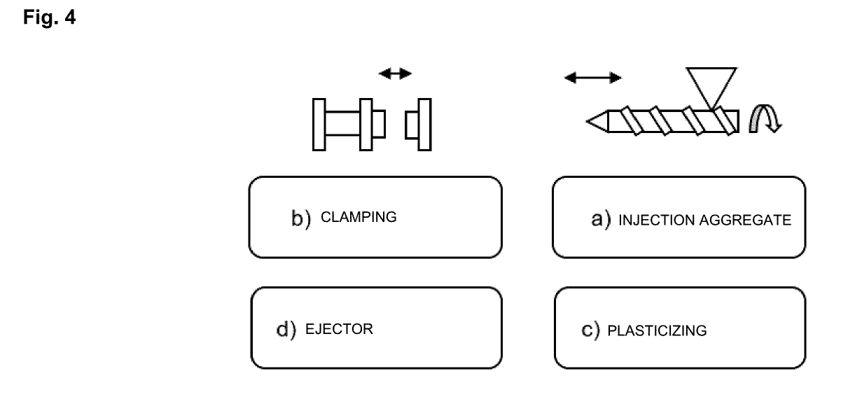

FIG. 4 a moulding machine.

In the following, an embodiment example of a method according to the invention is described. In order to illustrate the structure of the various objects involved in the method, reference may be made to FIG. 1.

The following embodiment example relates to injection-moulding processes (as moulding processes).
1. There are n actual injection-moulding machines which have clamped m different moulds and are set by users, process optimization systems or a combination of the two for the injection-moulding process.
2. On the basis of the process setting, the injection-moulding process can be started (theoretically this need not happen), by means of which and also by means of possible further user inputs at least one of the following variables describing the process (descriptive variables below) is present:
   a. mould data (weight, geometry of the cavity, etc.)
   b. machine data (machine configuration=>masses, lengths, limits, etc.)
   c. material data (viscosity, density, etc.)
   d. process settings and measured data (injection profile, switchover point, injection pressure measurement, etc.)
   e. user-related data (user role, user level, etc.)
   f. quality data (moulded part dimensions, moulded part weight, etc.)
3. The data are transmitted from the injection-moulding machine to the central memory.
4. On the central computer system, simulation models are generated in an automated manner with the aid of the transmitted descriptive variables from the actual injection processes. For this, the thermodynamics of the material injected into the cavity can also be taken into account in addition to the dynamics of the injection-moulding machine.

During the creation of the corresponding systems of equations, the topological structure of the hydraulic network, different mechanisms as well as the use of different subcomponents such as motors, pumps, etc. can implicitly be taken into account depending on the component selection. To describe mechanical components, a system of differential equations in the form of

M(q)\ddot{q}+g(q,\dot{q})=Q

is applied. The degrees of freedom are represented in the vector q, the mass matrix is represented by M(q) and further parts such as Coriolis terms, friction, etc. are represented in the vector g(q,\dot{q}). Forces applied by the drive system are found in vector Q. The form (\dot{⋅}) represents the time derivative. By solving such a system of equations, the translational motion of the screw in the injection unit, the motion of the clamping unit as well as the rotational motion of the screw are calculated.

For the translational motion of the screw, q=xₛ, \dot{q}=vₛ applies, whereby the volume flow into the cavity can be determined as

Q=Aₛvₛ

with the cross-sectional area of the screw Aₛ. The volume flow forms the input variable for the fluid-dynamic consideration of the compressible polymer melt during the process of injection into the cavity. The Navier-Stokes equations, the continuity equation and the conservation of energy are taken into account to calculate the behaviour. The volume-of-fluid model is used to reproduce the multiphase flows. The phase transport is described by

$$\frac{\partial α}{\partial t} + \vec{∇} \cdot ( \vec{u} α ) + \vec{∇} \cdot ( \vec{{u}_{r}} α ( 1 - α ) ) = {S}_{u} + {S}_{p}$$

with terms for the compressibility Sᵤ and Sₚ. α describes the phase state and u the velocity vector of the fluid. To reproduce the viscosity, the CrossWLF model is used with the zero viscosity η₀, the temperature T, the shear rate \dot{γ}, the pressure p and the material-specific parameters A₁, A₂, D₁, D₂, D₃, D₄:

$$η = \frac{{η}_{0}}{1 + ( \frac{{η}_{0} \dot{γ}}{{D}_{4}} ) ( 1 - n )}$$

$${η}_{0} = {D}_{1} \cdot exp ( \frac{( - {A}_{1} ) \cdot ( T - {D}_{2} - {D}_{3} \cdot p )}{( {A}_{2} + T - {D}_{2} - {D}_{3} \cdot p )} )$$

To reproduce the compressibility, the Tait model is used:

$$v = \frac{1}{ρ}$$

$$v ( p , T ) = {v}_{m} ( T ) \cdot [ 1 - C \cdot ln ( 1 + \frac{p}{{B}_{m} ( T )} ) ] T \geq {T}_{trans}$$

$$v ( p , T ) = {v}_{s} ( T ) \cdot [ 1 - C \cdot ln ( 1 + \frac{p}{{B}_{s} ( T )} ) ] + {W}_{s} ( T ) T \leq {T}_{trans}$$

with the density ρ, the specific volume v, and a dimensionless constant C. Tₜᵣₐₙₛ represents the liquid-to-solid state transition temperature. The following conditions apply to both phase states:

v_{m,s}(T)=b_{1m,s}+b_{2m,s}·(T−b₅)

B_{m,s}(T)=b_{3m,s}·exp(−b_{4m,s}·(T−b₅))

Tₜᵣₐₙₛ=b₅+b₆·p

Wₛ(T)=b₇·exp(b₈·(T−b₅)−b₉·p)

with material-specific parameters b_{1m,s}, b_{2m,s}, b_{3m,s}, b_{4m,s}, b₅, b₆, b₇, b₈, b₉. The pressure prevailing in the polymer melt acts as an opposing force on the screw.

The dynamic description of the machine and the fluid-dynamic description can include additional terms for taking external, or unknown, disturbances into account.

For controlling the respective component, implicit dependencies are also resolved in order to select and to parameterize necessary systems such as trajectory specifications and regulating systems. These are stored in a memory on the central computer.

The simulation is now finally configured.
5. By means of a comparison of simulation and measurement (available from the descriptive variables), model and process parameters that are unknown or are not precisely known can be identified. This can be carried out e.g. by minimizing error functions (least squares, etc.). Corresponding methods are known to a person skilled in the art. From this point in time, simulation and reality are assumed to be identical.
6. Based on this, according to the invention a difference between the process settings actually set on the actual machine and the process settings suggested by the POS for the simulation, or on the actual machine, is identified.
7. By means of a machine learning method, numerical optimization methods or a similar (learning) method which is, however, suitable for the technology of the POS, the process optimization system is adapted (trained, modified) such that qualitatively it makes the same decision (setting) as the user (or a selection or statistical mean of users) who carried out (changed) the setting on the actual injection-moulding machine. Plausibility checking of the process settings input by the user as well as checking of the quality parameters can be carried out.

Using the example of the switchover point, the adaptation can have e.g. the following appearance:
a. The POS determines the switchover point at V_{ND}=80%, relative to the total volume of the cavity (e.g. on the basis of initial expert knowledge implemented in an expert system)
b. The user on the actual injection-moulding machine corrects the switchover point to V_{ND,actual}=98%
c. Plausibility checking of the switchover point (between 1 and 100%) as well as user role checking (=process technician) of the actual injection-moulding machine are carried out.
d. The difference is identified and the system parameter “switchover point” V_{ND} is optimally adapted by means of solving the optimization problem

$$min ( {V}_{ND} - {V}_{ND , actual} ) {Q}_{{V}_{ND}} ( {V}_{ND} - {V}_{ND , actual} )$$

with the weighting factor Q. In this step, settings of n injection-moulding machines can be taken into account.

System parameters of the POS can be defined without restrictions, e.g. among other things as a non-linear function of material and mould parameters or as a function of machine limits such as maximum injection pressure, or the like. Moreover, system parameters need not necessarily represent process settings directly. The system parameters can also be used to evaluate quality parameters (e.g. weight) determined from the simulation and can then result in a determination of process settings (e.g. holding pressure time) by the POS.

In comparison with the state of the art, the POS in this embodiment example can be trained not only on the basis of actual data, but also through the application to a simulation adapted to reality (by measurement alignment). The data set set by the user, for example, is used in the simulation in order to evaluate quality parameters such as e.g. the flow front velocity. Here, the general correlation can be derived that a plurality of data sets optimally set by users produces an e.g. constant flow front velocity. In the case of an unknown moulded part in the future, a setting can thus be chosen such that the quality parameter flow front velocity is again constant. Thus it is not the settings that have been learned, but rather a commonality, generated therefrom, of a quality parameter (here constant flow front velocity), and for unknown moulded parts the optimal settings can thus again be determined. The learning of commonalities of quality parameters can be carried out e.g. by means of simple averaging (or median calculation, or the like) of features (here gradient of the flow front velocity) of the quality parameters determined from the simulation. The POS is then modified such that a setting results which produces the learned feature in the moulding process.

For the adaptation of the POS, a plurality of methods known from the literature can be used, such as least squares, see e.g. [1] from p. 245, numerical optimization methods (QP, NLP, etc.), see e.g. [1] from p. 448 and p. 529 respectively, supervised learning of neural networks, etc., see e.g. [2] from p. 73 and [3].
[1] J. Nocedal, S. Wright—Numerical Optimization; Springer, 2006
[2] Raul Rojas—Theorie der neuronalen Netze: Eine systematische Einführung; Springer-Lehrbuch, 1993
[3] J. J. Hopfield—Neural Networks and Physical Systems with Emergent Collective Computational Abilities; Proceedings of the National Academy of Sciences of the USA, Vol. 79, No. 8, 1982
   8. The POS applied to the simulation has now learned from n injection-moulding processes, and/or process settings adapted by the user, and “decides” in a similar optimal manner to the user. The required system parameters modified for the POS, and/or the modified POS, are stored in the memory and transmitted to all n (and optionally further) injection-moulding machines.

In FIG. 3, an embodiment example of a sequence according to the invention for configuring and carrying out a simulation is represented.

The configuration of the simulation starts with the selection of the injection-moulding machine components (A1). This overview of an injection-moulding machine includes the definition of an injection unit, a plasticizing unit, a clamping unit and an ejector system. These are selected by the local user's computer from predetermined lists of component names which are stored in a memory on the central computer and are linked to process-relevant variables (see also FIG. 4):
a) injection unit: injection volume, injection pressure
b) clamping unit: maximum clamping force
c) plasticizing unit: plasticizing capacity
d) ejector system: ejector stroke, maximum force

The selection of the respective component additionally requires the definition of the drive technology (electric/hydraulic). The selection, once made, of the components forms a first part of the configuration data which are transmitted to the central computer or memory and stored in the memory as part of the configuration.

In the next step (A2), geometric information about the mould is transmitted from the local user's computer via a remote data transmission connection to the central computer. In addition to the geometry, this includes information about the runner position and the cooling channels. Furthermore, the plastic to be injected is selected. For this, a list of material names is predetermined. The selection, once made, of the mould and of the material forms a second part of the configuration data which are also transmitted to the central computer. This completes the configuration, which is then stored in the central memory.

On the basis of the configuration, the simulation parameters (physical parameters) associated with the respectively selected component, such as e.g. lengths, masses, inertias, viscosity, compressibility, etc., are read from the database (B3) on the central computer or databases independent thereof (A3). The material parameters are obtained on the one hand from identification calculations (B2) by means of measurement processes of actual moulding processes (B1) and on the other hand from manufacturer's data (B4) or directly from databases.

On the basis of manufacturer's data, in addition further parameters of motors, ball screws, belts, etc. are determined and likewise stored in the database (B3). By means of the physical variables, systems of differential equations are generated for the mathematical description of the selected components (see also a)-d) in FIG. 4) and parameterized (A3).

For further details on model creation, reference may be made to point 4. of the embodiment example in conjunction with FIG. 1.

In the next step (A4), the simulation is created in the form of a program that can be compiled.

A setting data set can then be predetermined on the local user's computer (A5) and transmitted to the central computer. This includes process setting parameters such as clamping force, shot volume, injection speed, switchover point, injection cylinder temperature and mould temperature, etc.

On the basis of this complete configuration and parameterization, the simulation is initiated starting from the local user's computer and executed on the central computer (A6). The results are displayed on a local user's computer (A7) and used further.

1. Method for optimizing a process optimization system for a moulding machine, by means of which a cyclic moulding process is carried out for the production of a moulded part, wherein
(a) a setting data set is set by a user on the actual moulding machine,
(b) first values for at least one descriptive variable of the moulding process are obtained on the basis of the setting data set and/or on the basis of the cyclically carried out moulding process,
(c) second values for the at least one descriptive variable are obtained on the basis of data from the process optimization system,
(d) according to a predetermined differentiating criterion, it is checked whether the first values and the second values differ from each other and,
(e) if method step (d) shows that the first values and the second values differ from each other, the process optimization system is modified such that, when applied to the moulding machine and/or the moulding process, the first values for the at least one descriptive variable substantially result instead of the second values for the at least one descriptive variable.

2. Method according to claim 1, wherein, within the framework of carrying out method step (c) in a simulation of the moulding machine and/or of the moulding process, the process optimization system is applied and the second values are at least partially obtained from results of the simulation.

3. Method according to claim 2 using a mathematical model for the simulation, wherein parameters of the mathematical model describing the simulation are determined by minimizing error functions of measured and model variables.

4. Method according to claim 1, wherein the modified process optimization system is used in the case of the moulding machine and/or in the case of further moulding machines.

5. Method according to claim 1, wherein the modification of the process optimization system occurs by machine learning and/or numerical optimization methods and/or adaptation of an expert system.

6. Method according to claim 1, wherein, during the modification of the process optimization system, an error function between the first values and the second values is minimized for the at least one descriptive variable.

7. Method according to claim 1, wherein at least one of method steps (c), (d) and (e) is carried out on a computer which is separate from the moulding machine, wherein the first values for the at least one descriptive variable are transmitted to the computer, preferably via a remote data transmission connection.

8. Method according to claim 1, wherein at least one of the following—preferably after transmission by means of a remote data transmission connection—is stored in a memory which is separate from the moulding machine: the first values of the at least one descriptive variable, the second values of the at least one descriptive variable, the modified process optimization system.

9. Method according to claim 1, wherein the at least one descriptive variable includes parameters of the setting data set.

10. Method according to claim 1, wherein the at least one descriptive variable includes one or more of the following:
machine data which relate to a moulding machine used in the moulding process,
mould data which relate to a mould used in the moulding process,
material data which relate to a material used in the moulding process,
process settings and measured data which relate to the moulding process,
user-related data,
quality parameters which describe the moulded part.

11. Method according to claim 1, wherein the process optimization system makes use of at least one of the following: neural network, mathematical model, expert system, fuzzy logic.

12. Method according to claim 1, wherein the process optimization system is used to improve setting data sets for moulding machines, wherein at least one of the following quality criteria is preferably used as criterion for an improvement: reduced waste, reduced cycle time, improved moulding quality.

13. Method according to claim 1, wherein, when method step (c) is carried out and/or when the actual moulding process is carried out, set according to method step (a), quality parameters are determined and are used in the modification of the process optimization system according to method step (e).

14. Method for simulating a moulding process, according to claim 2, wherein
configuration data which relate to the moulding process to be simulated are provided on a user's computer,
the configuration data are transmitted by means of a remote data transmission connection to a memory which is separate from the moulding machine and the user's computer and stored therein,
a simulation program stored in the memory is executed, using the configuration data, on a computer which is connected to the memory and is separate from the moulding machine and the user's computer and
results generated by means of the simulation program are output,
wherein simulation parameters are automatically provided on the basis of the configuration data.

15. Method according to claim 14, wherein the generated results are transmitted by means of a remote data transmission connection to the user's computer or by means of a further remote data transmission connection to a further user's computer.

16. Method according to claim 14, wherein the configuration data include one or more of the following:
machine data which relate to a moulding machine used in the moulding process to be simulated, in particular dimensions, masses, inertias, motor constants, efficiencies and/or kinematics, of the moulding machine,
mould data which relate to a mould used in the moulding process to be simulated, in particular geometry, runner position and/or design of the tempering channels, of the mould,
data on subcomponents, in particular drives and/or pumps, of the moulding machine and/or of the mould,
material data which relate to a material used in the moulding process to be simulated, in particular viscosity, compressibility, specific volume and/or temperature constants,
data on environmental influences, in particular ambient temperature and/or ambient pressure and/or disturbances.

17. Method according to claim 14, wherein, in order to provide the simulation parameters, use is made of a database, which database contains parameters collected in actual moulding processes.

18. Method according to claim 1, wherein a setting data set is provided on the user's computer, transmitted by means of the remote data transmission connection to the simulation device, and the simulation program is executed using the setting data set.

19. Method according to claim 1, wherein the setting data set includes process setting parameters relating to at least one of the following: clamping force, shot volume, injection speed, switchover point, injection cylinder temperature, mould temperature, control and/or regulating parameters, holding pressure profile, holding pressure time, screw rotation speed, back pressure profile, cooling time, injection pressure limit, decompression stroke, tempering medium flow rate.

20. Method according to claim 14, wherein the descriptive variables are at least partially obtained from the results of the simulation.
